(19) United States
(12) Patent Application Publication
(10) Pub. No.: US 2009/0136608 A1
(43) Pub. Date: May 28, 2009

(54) APPARATUS FOR CONTINUOUS PRODUCTION OF A COMPOSITE PIPE WITH A PIPE SOCKET

(76) Inventor: Ralph Peter HEGLER, Bad Kissingen (DE)

Correspondence Address: Amy L. Hammer;Husch Blackwell Sanders LLP, Welsh & Katz, 120 South Riverside Plaza, 22nd Floor, Chicago, IL, 60606-3912, US

(21) Appl. No.: 12/273,231

(22) Filed: Nov. 18, 2008

(30) Foreign Application Priority Data
Nov. 28, 2007 (DE) 20 2007 016 630.3

(51) Int. Cl. B29C 55/22

(52) U.S. Cl. 425/112

(57) ABSTRACT

An apparatus for continuous production of a composite pipe comprises half shells which combine in pairs to form a molding path, wherein at least in one pair of half shells is formed a socket recess which has an extension b when seen in the conveying direction. Furthermore, an extrusion head is provided, with an outer die and an inner die leading out thereof, the outer die and the inner die having a distance a from each other when seen in the conveying direction. The distance a of the inner die from the outer die with respect to the extension b of the socket recess in the conveying direction is such that a≧b applies.

### BACKGROUND OF THE INVENTION

1. Field of the Invention

The invention relates to an apparatus of continuously producing a composite pipe with a pipe socket,
wherein half shells, which are provided with annular mold recesses and combine along a molding path to form a mold with a central longitudinal axis, are guided for circulation in a conveying direction,
wherein the mold recesses are connected to partial vacuum channels formed in the half shells,
wherein an extrusion head of at least one extruder is disposed in front of the molding path,
wherein the extrusion head is provided with an outer die for extrusion of an external tube and with an inner die, which is disposed downstream in the conveying direction for extrusion of an internal tube and with a calibration mandrel on its rear end when seen in the conveying direction,
wherein the inner die and the outer die have a distance a in the conveying direction,
wherein between the outer die and the inner die, at least one gas duct leads out of the extrusion head,
wherein between the inner die and the calibration mandrel, at least one additional gas duct leads out of the extrusion head,
wherein at least one pair of half shells is provided with a socket recess,
wherein the socket recess has an extension b in the conveying direction, and
wherein one transition area, which is directed outwards relative to the central longitudinal axis, is in each case formed at annular ribs located between the socket recess and adjacent mold recesses.

2. Background Art

An apparatus of this type is for example known from U.S. Pat. No. 7,238,317 B1. The greater the nominal widths of corrugated pipes, the more grow the elevations and thus the increase in size of the pipe socket in relation to the inside diameter of the composite pipe. This is due to the fact that the standard composite pipe is very often used as a spigot, meaning that a composite pipe is inserted by its elevations into the socket. The transition portions between the composite pipe disposed upstream during in-line production and the pipe socket on the one hand, and the pipe socket and the downstream composite pipe on the other, possess considerable radial extension. In particular the transition portion between a composite pipe and socket, which remains after separation of the extruded continuous run of pipe, must possess pronounced radial extension i.e., must be directed steeply outwards in relation to the central longitudinal axis, so that, upon insertion of the spigot into the socket as far as to the transition portion, there will be no dead space, nor considerable dead space, where dirt might deposit. The greater the nominal widths and/or the higher the production rate, the greater the risk that the internal tube does not adhere by its full face to the external tube in the vicinity of the transition portion and at the beginning and end of the socket. In the apparatus disclosed in U.S. Pat. No. 7,238,317 B1, these problems were solved by providing a recess in the at least one annular rib for connecting the transition area with the adjacent annular mold recess. This provides for evacuation of the space between the internal tube and the external tube in the vicinity of the transition portion, strictly speaking at the transition between the composite pipe and the pipe socket, to ensure that the pressure exerted on the internal tube from outside causes the entire surface of the internal tube to be pressed against the corresponding region of the external tube to which it is welded. This solution proved to be exceptionally suitable. In particular in the case of very large nominal pipe widths, problems may still occur when molding the pipe socket for twin-wall composite pipes.

### SUMMARY OF THE INVENTION

Thus it is the object of the invention to develop an apparatus of the generic type such that even in the case of large nominal widths, a good molding of the pipe socket is achieved.

This object is attained according to the invention in that the distance a of the inner die from the outer die with respect to the extension b of the socket recess in the conveying direction is such that a≧b. The gist of the invention is that the apparatus is designed such that the molding of the pipe socket from the internal tube leaving the inner die does not start until the external tube leaving the outer die is in full contact with the socket recess in the vicinity thereof and this contact with the two annular ribs defining the socket recess is well sealed. In the vicinity of the pipe socket to be molded, the external tube already has its defined shape when the portion of the internal tube is extruded which is used for molding the pipe socket. The distance of inner die and outer die may naturally be increased even more so that the external tube already covers several upstream and downstream annular ribs when the extrusion of the internal tube, which is to be molded into the pipe socket, starts.

Further features, advantages and details of the invention will become apparent from the following description of an exemplary embodiment by means of the drawing.

### BRIEF DESCRIPTION OF THE DRAWINGS

FIG. 1 shows a schematic plan view of an apparatus for the production of composite pipes comprising pipe sockets, the apparatus substantially comprising two extruders, a molding machine and an aftercooler;

FIG. 2 shows a horizontal section through an extrusion head and the leading end of the molding machine;

FIG. 3 shows a vertical partial longitudinal section through the molding machine during the production of a standard composite pipe immediately before the production of a pipe socket starts;

FIG. 4 shows the vertical partial longitudinal section according to FIG. 3 in a position during the production of the pipe socket;

FIG. 5 shows the vertical partial longitudinal section according to FIGS. 3 and 4 in a position as the production of the pipe socket continues;

FIG. 6 shows an enlarged partial section according to line VI in FIG. 5;

FIG. 7 shows the vertical partial section according to FIGS. 3, 4, 5 when the production of the pipe socket is complete;

FIG. 8 shows the vertical partial longitudinal section according to FIGS. 3, 4, 5, 7 during the subsequent production of a standard composite pipe;

FIG. 9 shows a composite pipe produced on the apparatus, the composite pipe comprising a pipe socket; and

FIG. 10 shows a cross-sectional view of the composite pipe according to the section line X-X in FIG. 9.

### DESCRIPTION OF THE PREFERRED EMBODIMENT

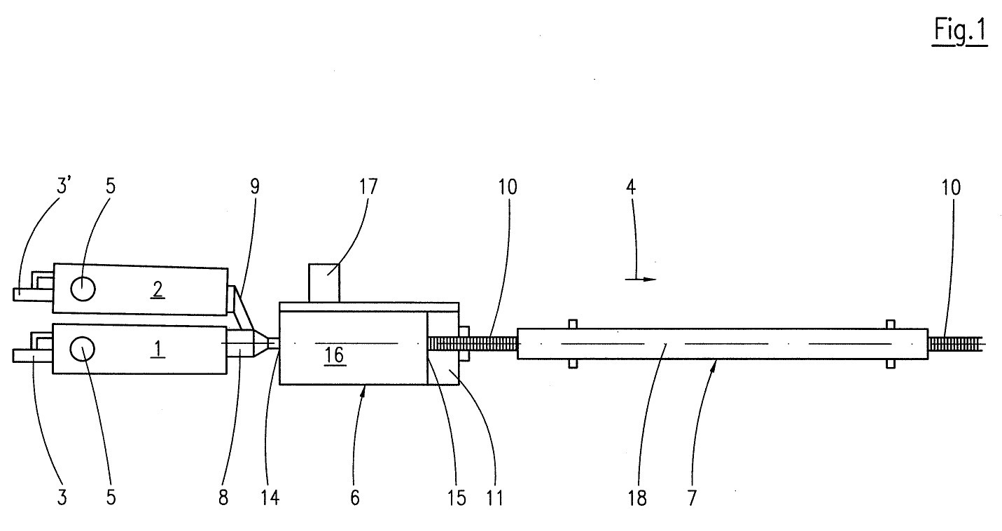

The installation shown in FIG. 1 for the manufacture of composite pipes comprises two extruders 1, 2. Each of them is driven by a variable speed drive motor 3 and 3′ which, related to the conveying direction 4 of the entire installation, is provided upstream of the feed hoppers 5 of the extruders 1, 2.

Downstream of the extruders 1, 2 as seen in the conveying direction 4, provision is made for a molding machine 6, a so-called corrugator, which is followed by an aftercooler 7. A crosshead 8, which projects into the molding machine 6, is mounted on the extruder 1 which is in alignment with the molding machine 6 and the aftercooler 7. The other extruder 2, by the side of the extruder 1, is connected to the crosshead 8 by way of an injection channel 9 which discharges laterally into the crosshead 8. As diagrammatically outlined in FIG. 1, a composite pipe 10 is molded in the molding machine 6; it leaves the molding machine 6 in the conveying direction 4 and is cooled in the aftercooler 7. Downstream of the aftercooler 7, it can then be cut into pieces of appropriate length.

The design of the molding machine 6 is known and common practice. It is described for example in U.S. Pat. No. 5,320,797, to which reference is made explicitly. It substantially comprises a machine bed 11 with half shells 12, 12′ disposed thereon, which are joined to each other, constituting two so-called chains 13, 13′. These chains 13, 13′ are guided along deflection rollers (not shown) at the upstream inlet 14 and the downstream outlet 15 seen in the conveying direction 4. When circulating in the conveying direction 4, they are guided such that every two half shells 12, 12′ are united into a pair, with pairs of shells closely succeeding to each other in the conveying direction 4. A drive motor 17 serves for actuation of the half shells 12, 12′ which are united on a molding path 16, forming pairs of shells.

The crosshead 8 comprises two melt channels which are concentric of a joint central longitudinal axis 18, namely an inner melt channel 19 and an outer melt channel 20 which, seen in the conveying direction 4, terminate downstream in an inner die 21 and outer die 22. The inner melt channel 19 is connected to an injection channel 23 of the extruder 1 which is in alignment with the molding machine 6, whereas the outer melt channel 20 is connected to the injection channel 9 of the other extruder 2. Between the inner die 21 and the outer die 22, a gas duct 24 discharges from the crosshead 8, the gas duct 24 on the one hand being connectable by way of a valve to a source of compressed gas for so-called stabilizing air to be blown in or on the other hand to atmosphere.

A calibrating mandrel 25, which is also concentric of the axis 18, is mounted on the extrusion head 8 at the downstream end thereof seen in the conveying direction 4. It has cooling channels 26 for cooling water which is supplied via a cooling-water flow pipe 27 and led off via a cooling-water return pipe 28. Further provision is made for an air pipe 29 connected to a gas gap 30 which serves as an additional gas duct and, as seen in the conveying direction 4, is located directly downstream of the inner die 21 between the extrusion head 8 and the calibrating mandrel 25. The pipes 27, 28, 29 pass through an approximately tubular supply channel 31 which is provided in the extrusion head 8 concentrically of the axis 18.

The half shells 12, 12′ have annular mold recesses 32, 32′ that succeed to each other at regular distances, each of them being connected to partial-vacuum channels 33. Upon arrival of the half shells 12, 12′ on the molding path 16, the partial-vacuum channels 33 reach partial-vacuum supply sources 35 and 36 so that partial vacuum is applied to the mold recesses 32.

The plastic melt, which is supplied by the extruder 2 through the injection channel 9 and to the extrusion head 8, flows through the outer melt channel 20 to the outer die 22 where it is extruded, forming an external tube 37. Owing to the partial vacuum, this tube 37 gets seated in the mold recesses 32, 32′, forming a tube that is provided with annular elevations 38. Plastic melt is supplied from the extruder 1 through the injection channel 23 to the extrusion head 8, flowing through the inner melt channel 19 towards the inner die 21 where it discharges as an internal tube 39 that approaches the calibrating mandrel 25. The calibrating mandrel 25 expands slightly outwards from the inner die 21 on in the conveying direction 4 until the internal tube 39 bears against the corrugation troughs 40 of the external tube 37 where both of them are welded together. Once cooled and solidified, the internal tube 39 and the external tube 37 constitute the composite pipe 10.

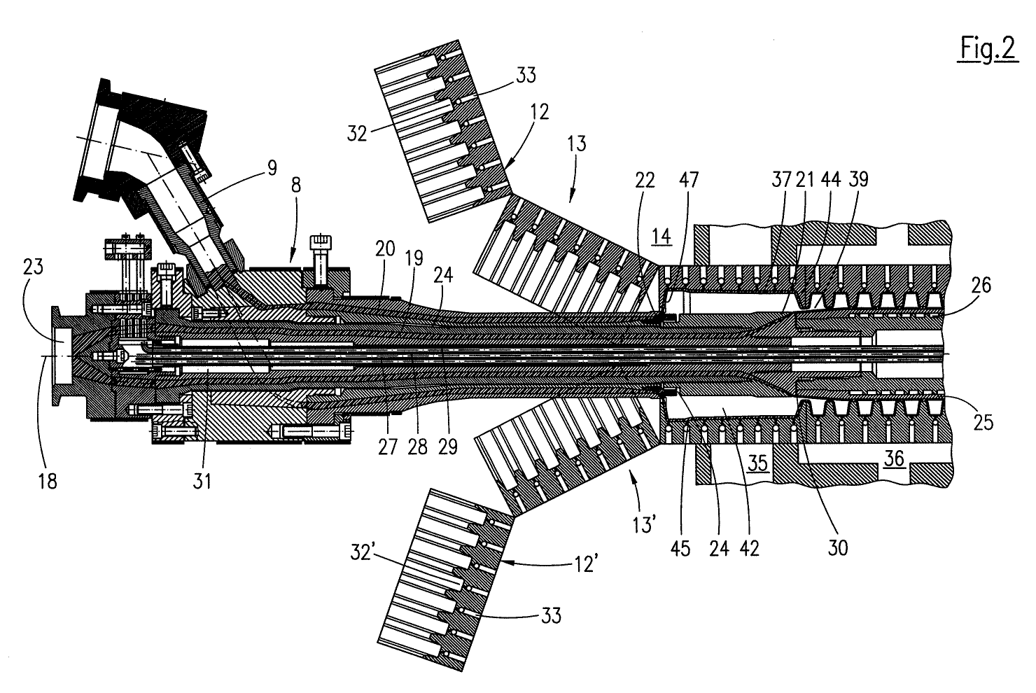

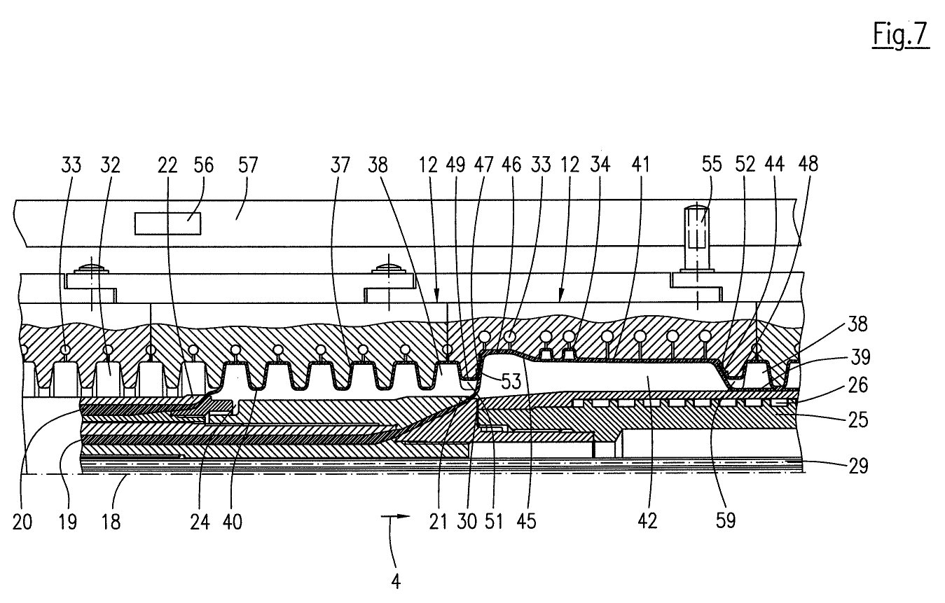

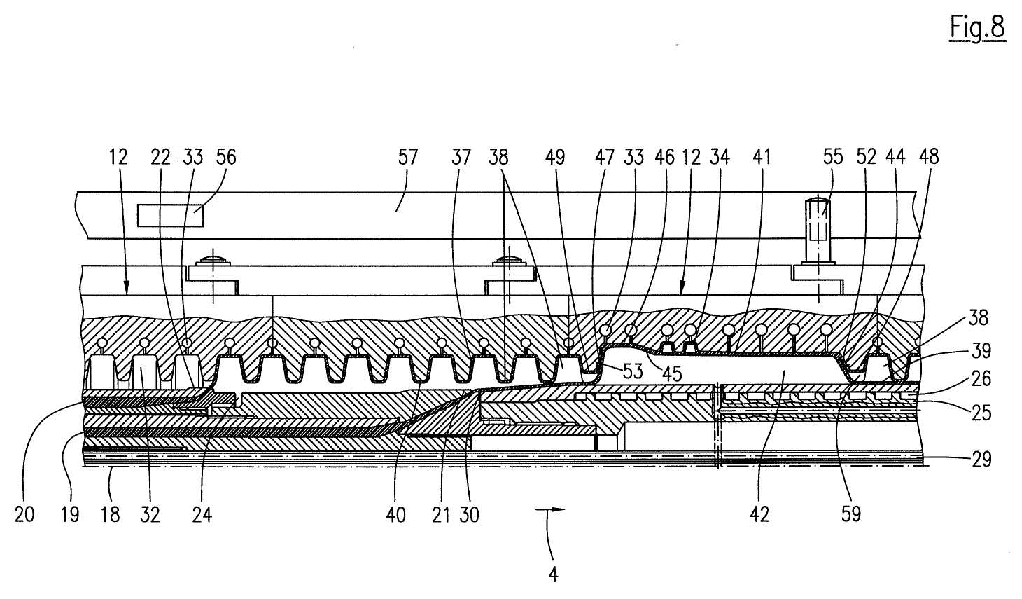

As in particular shown by FIGS. 2, 3, 4, 5, and 7, 8, the half shells 12, 12′ are designed for pipe sockets 41 to form at regular distances within the continuous composite pipe 10. To this end, a socket recess 42 is formed in a pair of half shells 12, 12′, having a substantially smooth, cylindrical wall 43. A transition area 44 is formed between the wall 43 of the socket recess 42 and the mold recess 32 upstream in the conveying direction 4. The lagging end, as seen in the conveying direction 4, of the wall 43 of the socket recess 42 is followed by peripheral grooves 34 for reinforcement of the socket 41 and a truncated mold portion 45 where an insertion end 46 of the socket 41 is formed, expanding outwards. This is again followed by a transition area 47 that leads to the next mold recess 32 disposed downstream as seen in the conveying direction 4.

As far as described hereinbefore, the apparatus is substantially known from U.S. Pat. No. 6,458,311 B1 and U.S. Pat. No. 7,238,317 B1 which are expressly referred to.

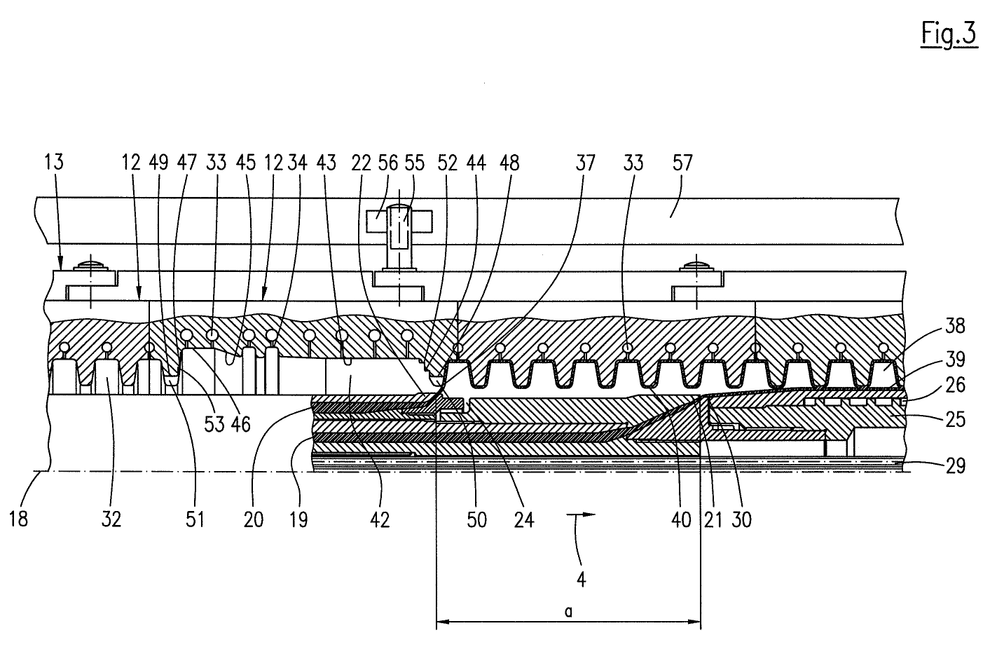

As seen in FIGS. 3 to 7, on the transition area 44 upstream in the conveying direction and on the transition area 47 downstream in the conveying direction 4, slotted recesses 50, 51, which run in the direction of the axis 18, are formed in the vicinity of the produced corrugation trough 40 on the annular rib 48 and 49 that forms the respective transition area 44 and 47, of the half shell 12, 12′. These recesses 50, 51 connect the respective transition area 44 and 47 to the next adjacent annular elevation 38. The recesses 50, 51 of each annular rib 48, 49 are interconnected by connecting grooves 52, 53 which extend along the periphery of the respective transition area 44 and 47 and are formed therein as it is disclosed in U.S. Pat. No. 7,238,317 B1.

As illustrated by FIGS. 3 to 8, the half shell 12 that locates the socket recess 42 is sufficiently long for the annular ribs 48, 49 to be completely contained therein. Unlike FIG. 2 which, in this regard, is merely a diagrammatic illustration, the separation of adjacent half shells 12 does not take place through the annular rib 48 and 49, which is advantageous in terms of manufacture. With the socket recess 42 being sufficiently long to reach over more than one half shell 12, then this applies correspondingly to these half shells 12.

As illustrated by FIGS. 3 to 8 as well, the inner die 21 has a distance a from the outer die 22 when seen in the conveying direction 4. The transition area 44 further has a distance b from the transition area 47, the distance b thus corresponding to the longitudinal extension of the socket recess 42. The distance a may naturally also exceed b. For instance, the length of distance a may be such that it covers even the annular ribs 48, 49 defining the socket recess 42 or even the annular ribs next to the annular ribs 48, 49. Thus, the following applies: a≧b.

By locally defined allocation to the socket recess 42, a rod-shaped switch member 55 is connected to the corresponding half shell 12, operating a switch 56 by means of which to modify the speed and thus the extrusion rate of the extruders 1, 2 and by means of which to supply the gas duct 24 and the gas gap 30. To this end, an arm 57 is mounted on the molding machine 6, running in the conveying direction 4 above the half shells 12, 12′. This is where the switch 56 is mounted which is operated by the switch member 55. As seen in FIGS. 3 to 5, this switch 56 is being operated. The jobs of modifying the speed of the extruder 2 that furnishes the plastic melt for manufacture of the external tube 37, triggering the so-called stabilizing air that flows from the gas duct 24, evacuation via this gas duct 24, triggering the gas gap 30 at the calibrating mandrel 25, and finally modifying the speed and thus the extrusion rate of the extruder 1 which furnishes the plastic melt for manufacture of the internal tube 39, take place via the software of a control system to which the switch 56, upon operation, transmits a reference signal.

Upon manufacture of the standard corrugated composite pipe 10 in the way seen in FIG. 3 at the right, the external tube 37 is retracted by the partial vacuum into the mold recesses 32 where it adheres. In this process, a low over pressure of 0.2 to 0.4 bar, relative to atmospheric pressure, is applied to the gas duct 24. The low over pressure between external tube 37 and internal tube 39 ensures that the internal tube 39 does not bulge radially outwards into the elevation 38 when the tubes 37, 39, which are welded together at the corrugation troughs 40, cool down to form the corrugated composite pipe 10. When the hoses 37, 39 cool down, approximately atmospheric pressure builds up between the hoses 37, 39.

When the aforementioned low over pressure is applied to the gas duct 24, a partial vacuum or a low over pressure is simultaneously applied to the gas gap 30. A partial vacuum is in particular applied to the gas gap 30 if the plastic material used for the hoses 37, 39 is a polyethylene or a polypropylene material. The partial vacuum at the calibration mandrel ensures that a smooth inner surface of the internal tube 39, and ultimately of the internal pipe 39′, is maintained. This process is referred to as the so-called vacuum calibration. When PVC is used as plastic material for the production of the hoses 37, 39, it is suitable to apply a low over pressure of 0.05 to 0.15 bar above atmospheric pressure to the gas gap 30. This pressure is thus lower than the one which is applied to the gap 58 between internal tube 39 and external tube 37 via the gas duct 24. When the aforementioned plastic material is used, the low over pressure in the internal tube 39 prevents the internal tube 39 from adhering to the calibration mandrel 25 before it is welded with the external tube 37.

When the standard corrugated composite pipe 10 is produced as described above, the extruders 1, 2 are operated at a defined speed, in other words they extrude in each case a constant mass flow of plastic melt per unit time.

When the transition area 44 moves into the vicinity of the outer die 22 at the instant seen in FIG. 3, the switch member 55 reaches the switch 56, by actuation of which the speed of the drive motor 3′ of the extruder 2 decreases, reducing the extrusion rate i.e., the flow of plastic melt per unit time. As a result of the reduction in speed of the extruder 2, the external tube 37, which gets seated on the transition area 44 and the wall 43 of the socket recess 42 by reason of the partial vacuum, contains less plastic material per unit length of the composite pipe 10 than in such area of the standard corrugated composite pipe 10 where it is shaped into an external pipe 37′ with elevations 38. Depending on the degree to which the speed is reduced, the wall thickness in the vicinity of the socket 41 can be equal to, or greater or less than, that in the vicinity of the elevations 38 of the composite pipe 10. Corresponding adaptation or modification of the wall thickness in the vicinity of the socket 41 can also be attained in known manner by increase of the speed of the half shells 12, 12′ that constitute the mold 32. On the other hand, an increase in wall thickness in the vicinity of the socket 41 can also be obtained by increasing the speed of the extruder 2 and, respectively, reducing the speed of the mold 32.

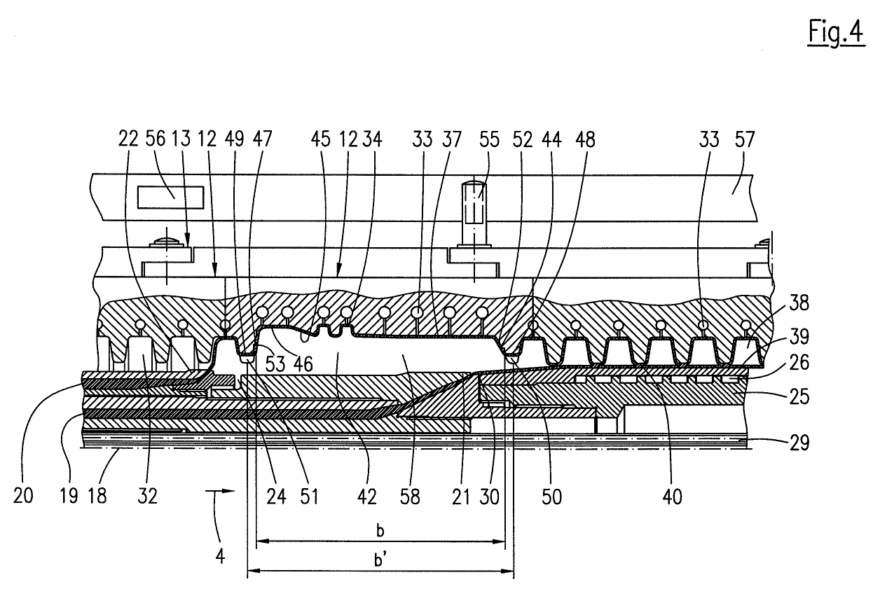

When the transition area 44 reaches the inner die 21, corresponding approximately to the illustration of FIG. 4, the over pressure or low pressure of the air that leaves the gas gap 30 is being raised for example to an over-pressure of approximately 0.05 to 0.2 bar (in the case of a preceding low pressure) or approximately 0.2 to 0.4 bar (in the case of a preceding over-pressure), respectively.

At the same time, the over pressure is removed from the gas duct 24 which is then connected to atmosphere for evacuation of the gap 58 between internal tube 39 and external tube 37 in the vicinity of the socket recess 42. The internal tube 39 is pressed outwards against the external tube 37. As also shown in FIG. 4, the internal tube 39 is not pressed against the external tube 37 until the external tube 37 adheres to the wall 43 of the socket recess 42 along the entire length. The external tube 37 thus adheres to both the annular rib 48 disposed upstream of the socket recess 42 in the conveying direction 4 and to the annular rib 49 disposed downstream thereof. Thus, the molding of the pipe socket 41 from the internal tube 39 does not start until the molding of the pipe socket 41 from the external tube 37 is complete. Consequently, the internal tube 39 is not brought into contact with the external tube 37 already molded into the pipe socket until the external tube 37 has reached a stable position at the wall 43 of the socket recess 42, said position being achieved by the sealing at the adjacent annular webs 48, 49 and by the effect of the partial vacuum in the mold recess 32. The distance a may therefore also be equal to or larger than the central distance b′ of the annular ribs 48, 49.

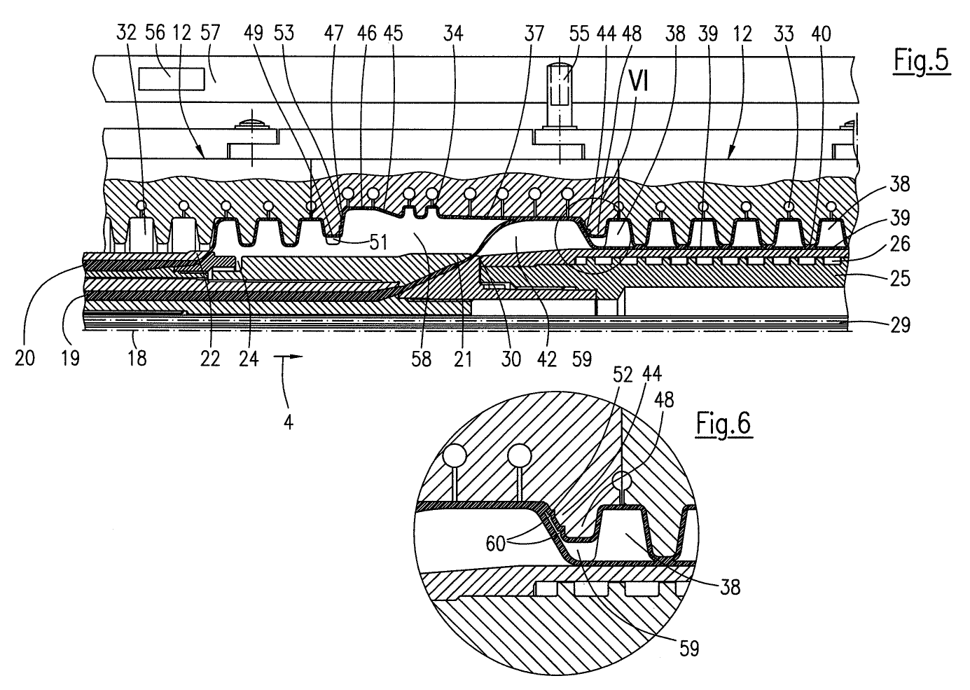

As can be seen from FIGS. 5 and 6, the external tube 37 gets seated on the annular rib 48 and the transition area 44, with an overflow passage 59 being simultaneously formed in the vicinity of the slotted recesses 50, leading into the adjacent elevation 38. At the transition area 44, the external tube 37 also gets placed in the connecting grooves 52, thereby forming connecting passages 60 in the molded external pipe 37′. The internal tube 39, by the pressure prevailing therein, is forced against the external tube 37, but it is not pressed or molded into the overflow passages 59 and the connecting passages 60 so that these passages 59, 60 are maintained between the external tube 37 and the internal tube 39. The air located in this area can flow off into the elevation 38 upstream in the conveying direction. In the transition portion 61 between the standard composite pipe 10 and the in-line molded socket 41, the external tube 37 and the internal tube 39 are being welded together nearly full face. This connection by welding does not exist in the vicinity of the overflow passages 59 and the connecting passages 60. This design enables the transition portion 61, related to the conveying direction 4, to be embodied strongly radial i.e., ascending comparatively steeply.

When the transition area has passed the inner die 21, the drive motor 3 of the extruder 1 is being triggered in such a way that for instance its speed rises, which means that the flow rate per unit time of the plastic melt is increased. Consequently, more plastic melt per unit length is supplied to the internal tube 39 in the vicinity of the produced socket 41 than in the vicinity of the standard corrugated composite pipe 10 where only the smooth internal pipe 39′ is made from it.

When the transition area 47 of the socket recess 42 passes the outer die 22, the extrusion rate of the extruder 2 that delivers the external tube 37 is being set back to the original rate. The extruder 2 again supplies the amount per unit time of the plastic melt that is necessary for producing the elevations 38. The external tube 37 rests on the transition area 47 and the connecting grooves 53 formed therein, thus producing connecting passages 62 in the external tube. Then the external tube bears against the annular rib 49 and is molded into the slotted recesses 51, forming overflow channels corresponding to the overflow channels 59.

When the transition area 47 reaches the inner die 21, then the gas pressure that acts at the gas gap 30 is again reduced and compressed air and so-called stabilizing air is applied to the gas duct 24, which means the process returns to conditions that prevail upon manufacture of the standard composite pipe 10. When the transition area 47 has passed the inner die 21, the drive motor 3 is being triggered, whereby the extrusion rate of the extruder 1 is reduced to the original rate so that again the amount of plastic melt per unit time is extruded that is needed for manufacture of the smooth internal pipe 39′.

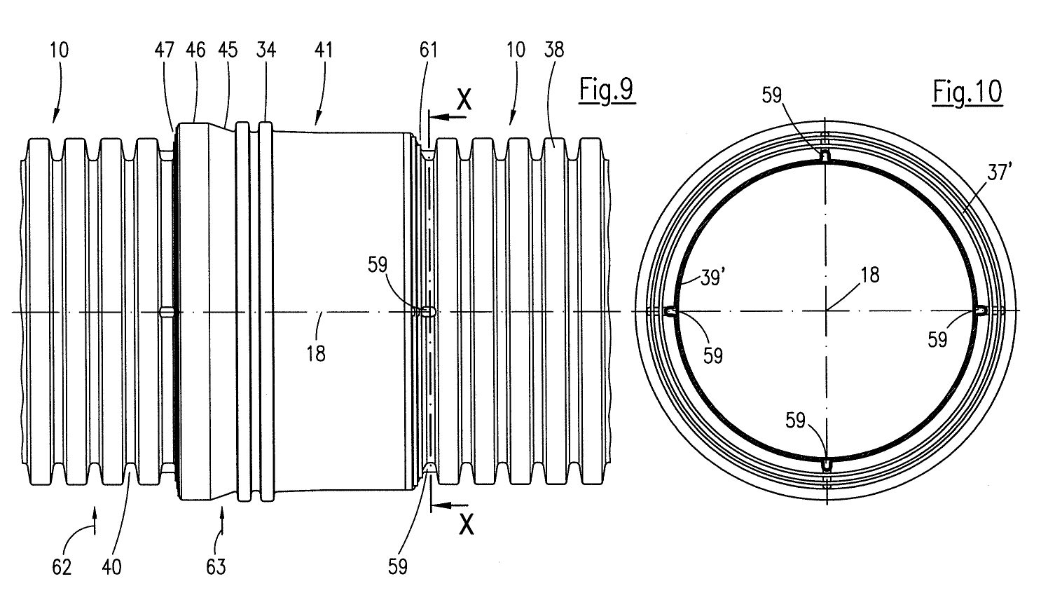

The endless, in-line molded composite pipe 10 shown in FIGS. 9 and 10 is cut in the vicinity of the transition area 47 downstream in the conveying direction 4, namely by means of two cuts 62, 63.

What is claimed is:

1. An apparatus of continuously producing a composite pipe,
wherein half shells (12, 12′), which are provided with annular mold recesses (32) and combine along a molding path (16) to form a mold with a central longitudinal axis (18), are guided for circulation in a conveying direction (4);
wherein the mold recesses (32) are connected to partial vacuum channels (33) formed in the half shells (12, 12′);
wherein an extrusion head (8) of at least one extruder (1, 2) is disposed in front of the molding path (16);
wherein the extrusion head (8) is provided with an outer die (22) for extrusion of an external tube (37) and with an inner die (21), which is disposed downstream in the conveying direction (4) for extrusion of an internal tube (39) and with a calibration mandrel (25) on its rear end when seen in the conveying direction (4);
wherein the inner die (21) and the outer die (22) have a distance a in the conveying direction (4);
wherein between the outer die (22) and the inner die (21), at least one gas duct (24) leads out of the extrusion head (8);
wherein between the inner die (21) and the calibration mandrel (25), at least one additional gas duct (30) leads out of the extrusion head (8);
wherein at least one pair of half shells (12, 12′) is provided with a socket recess (42);
wherein the socket recess (42) has an extension b in the conveying direction (4);
wherein one transition area (44, 47), which is directed outwards relative to the central longitudinal axis (18), is in each case formed at annular ribs (48, 49) located between the socket recess (42) and adjacent mold recesses (32); and
wherein the distance a of the inner die (21) from the outer die (22) with respect to the extension b of the socket recess (42) in the conveying direction (4) is such that a≧b applies.

2. An apparatus according to claim 1,
wherein a>b applies.

3. An apparatus according to claim 1,
wherein relative to the conveying direction (4), an annular rib (48, 49) is formed downstream and upstream between the socket recess (42) and in each case one adjacent mold recess (32); and
wherein the distance a of the inner die (21) and the outer die (22) corresponds at least to the central distance b′ of the annular ribs (48, 49) from one another.
